(19) United States
(12) Patent Application Publication
(10) Pub. No.: US 2019/0080672 A1
(43) Pub. Date: Mar. 14, 2019

(54) DATA PROCESSING DEVICES, DATA PROCESSING METHODS, AND COMPUTER-READABLE MEDIA

(71) Applicant: RAZER (ASIA-PACIFIC) PTE. LTD., Singapore (SG)

(72) Inventors: Ping HE, Alameda, CA (US); Tim Michael ADAMS, Encinitas, CA (US); Mark U. DE JONG, Poway, CA (US); Robert TARASOV, Dublin, CA (US)

(73) Assignee: RAZER (ASIA-PACIFIC) PTE. LTD., Singapore (SG)

(21) Appl. No.: 16/081,893

(22) PCT Filed: Mar. 2, 2016
(86) PCT No.: PCT/US16/20325

§ 371 Date: Aug. 31, 2018

(51) Int. Cl. G09G 5/14; G06F 3/14; G06F 3/0484

(52) U.S. Cl. CPC G09G 5/14; G09G 2340/12; G06F 3/0484; G06F 3/14

(57) ABSTRACT

According to various embodiments, a data processing device may be provided. The data processing device may include: an input circuit configured to receive graphical output from an application, program and a plurality of data sets; a determination circuit configured to determine for each data set of the plurality of data sets whether the respective data is to be included in a first output which is visible on a screen of a computer on which the application program is running and to determine for each data set of the plurality of data sets whether the respective data is to be included in a second output which is not visible on the screen, wherein the first output includes the respectively determined data sets and the graphical output from the application program, wherein the second output includes the respectively determined data sets and the graphical output from, the application program; a display interface configured to output the first output to the screen; and an output generation circuit configured to generate the second output.

### TECHNICAL FIELD

Various embodiments generally relate to data processing devices, data processing methods, and computer-readable media.

### BACKGROUND

During running an application, it may be desired to provide various kinds of information to a user. Thus, there may be a need for efficient management of such information.

### SUMMARY OF THE INVENTION

According to various embodiments, a data processing device may be provided. The data processing device may include: an input circuit configured to receive graphical output from an application program and a plurality of data sets; a determination circuit configured to determine for each data set of the plurality of data sets whether the respective data is to be included in a first output which is visible on a screen of a computer on which the application program is running and to determine for each data set of the plurality of data sets whether the respective data is to be included in a second output which is not visible on the screen, wherein the first output includes the respectively determined data sets and the graphical output from the application program, wherein the second output includes the respectively determined data sets and the graphical output from the application program; a display interface configured to output the first output to the screen; and an output generation circuit configured to generate the second output.

According to various embodiments, a data processing method may be provided. The data processing method may include: receiving graphical output from an application program and a plurality of data sets; determining for each data set of the plurality of data sets whether the respective data is to be included in a first output which is visible on a screen of a computer on which the application program is running; determining for each data set of the plurality of data sets whether the respective data is to be included in a second output which is not visible on the screen, wherein the first output includes the respectively determined data sets and the graphical output from the application program, wherein the second output includes the respectively determined data sets and the graphical output from the application program; outputting the first output to the screen; and generating the second output.

According to various embodiments, a computer-readable medium may be provided. The computer-readable medium may include instructions which, when executed by a computer, make the computer perform a data processing method, the data processing method including: receiving graphical output from an application program and a plurality of data sets; determining for each data set of the plurality of data sets whether the respective data is to be included in a first output which is visible on a screen of a computer on which the application program is running; determining for each data set of the plurality of data sets whether the respective data is to be included in a second output which is not visible on the screen, wherein the first output includes the respectively determined data sets and the graphical output from the application program, wherein the second output includes the respectively determined data sets and the graphical output from the application program; outputting the first output to the screen; and generating the second output.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. The dimensions of the various features or elements may be arbitrarily expanded or reduced for clarity. In the following description, various embodiments of the invention are described with reference to the following drawings, in which:

FIG. 1A shows a data processing device according to various embodiments;

FIG. 1B shows a data processing device according to various embodiments;

FIG. 1C shows a flow diagram illustrating a data processing method according to various embodiments; and

FIG. 2 shows an illustration of an architecture according to various embodiments; and

FIG. 3A to FIG. 3H show illustrations of an embodiment applied on a personal computer with a game playing.

### DETAILED DESCRIPTION

The following detailed description refers to the accompanying drawings that show, by way of it specific details and embodiments in which the invention may be practiced. These embodiments are described in sufficient detail to citable those skilled in the art to practice the invention. Other embodiments may be utilized and structural, and logical changes may be made without departing from the scope of the invention. The various embodiments are not necessarily mutually exclusive, as some embodiments can be combined with one or more other embodiments to form new embodiments.

In this context, the data processing device as described in this description may include a memory which is for example used in the processing carried out in the data processing device. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex instruction Set Computer (CIBC) processor or a Reduced Instruction Set Computer (RISC) processor). A “circuit” may also be a processor executing software, e.g. any kind of computer program, e.g. a computer program using a virtual machine code such as e.g. Java, or a the computer virtual machine, e.g. VMWare virtual machines or VirtualBox virtual machines

Any other kind of implementation of the respective functions which will be described in more detail below may also be understood as a “circuit” in accordance with an alternative embodiment.

In the specification the. term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

The reference to any prior art in this specification is not, and should not be taken as an acknowledgement or any form of suggestion that the referenced prior art forms part of the common general knowledge in Australia (or any other country).

In order that the invention may be readily understood and put into practical effect, particular embodiments will now be described by way of examples and not limitations, and with reference to the figures.

Various embodiments are provided for devices, and various embodiments are provided for methods. It will be understood that basic properties of the devices also hold for the methods and vice versa. Therefore, for sake of brevity, duplicate description of such properties may be omitted.

It will be understood that any property described herein for a specific device may also hold for any device described herein. It will be understood that any property described herein for a specific method may also hold for any method described herein. Furthermore, it will be understood that for any device or method described herein, not necessarily all the components or steps described must be enclosed in the device or method, but only some (but not all) components or steps may be enclosed.

The term “coupled” (or “connected”) herein may be understood as electrically coupled or as mechanically coupled, for example attached or fixed, or just in contact without any fixation, and it will be understood that both direct coupling, or it coupling (in other words: coupling without direct contact) may be provided.

During running an application, it may be desired to provide various kinds of information to a user. According to various embodiments, efficient management of such information may be provided.

According to various embodiments, devices and methods for inclusive and exclusive in-game overlay generation may be provided.

In-game overlay technology may be used to build in-game Apps or features such that garners can use enhanced features to enrich gaming experience. According to various embodiments, devices and methods may be provided to generate in-game overlays with selective recording capabilities to maximize gaming experience for both gamers and game viewers. According to various embodiments, a single frame usage may be provided. According to various embodiments, a multi-frame usage may be provided. A single frame usage may be based on a screenshot and multi-frame may be based on recording local or streaming to a secondary device.

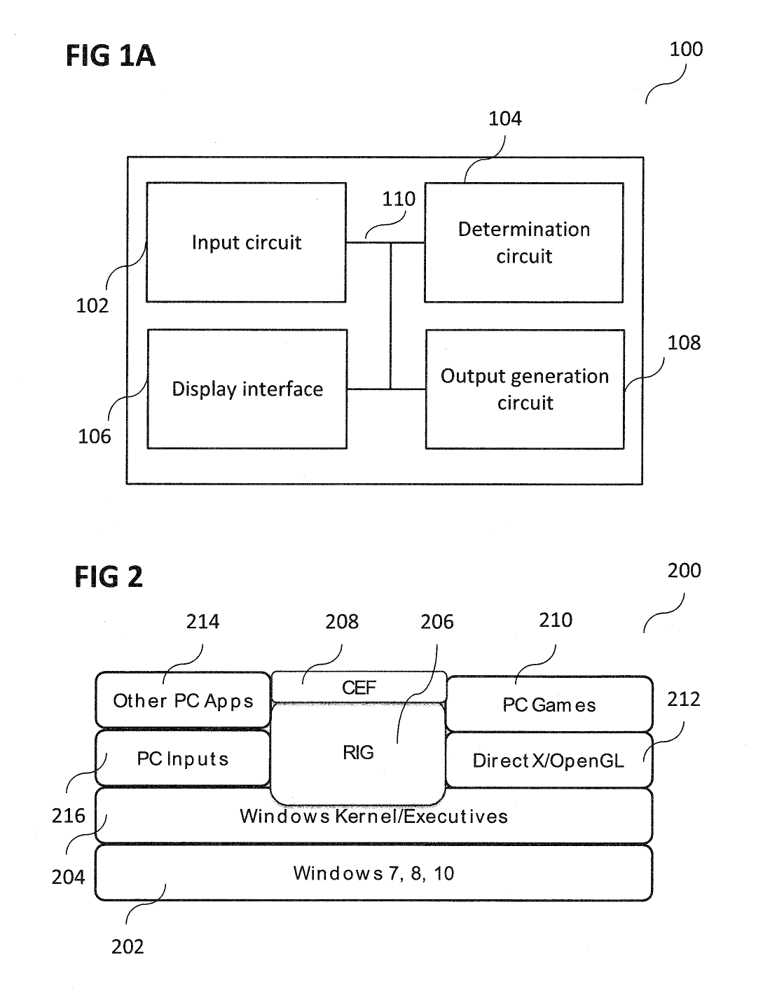

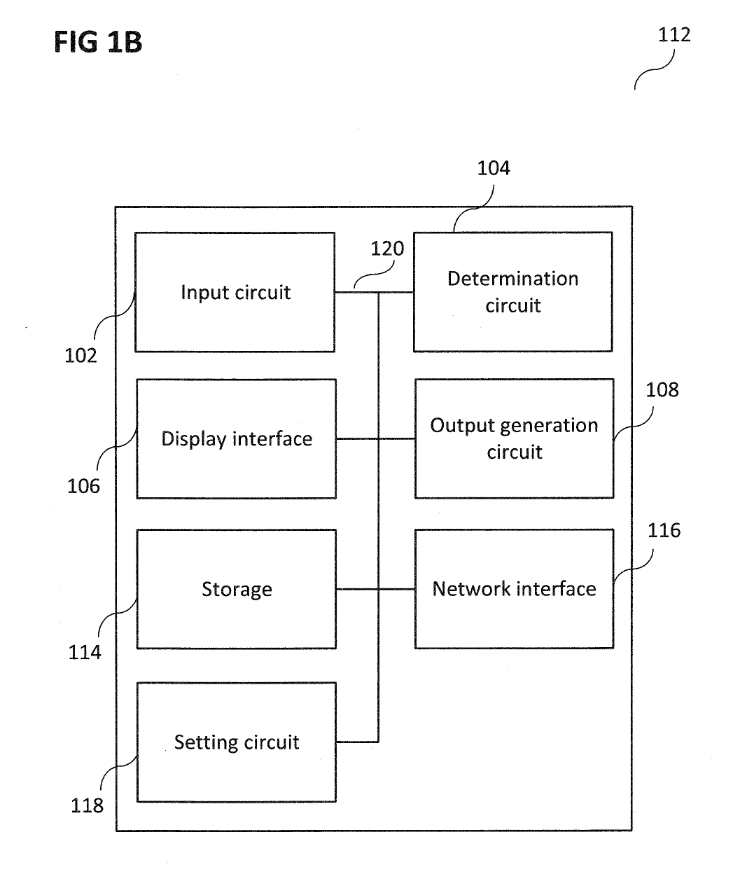

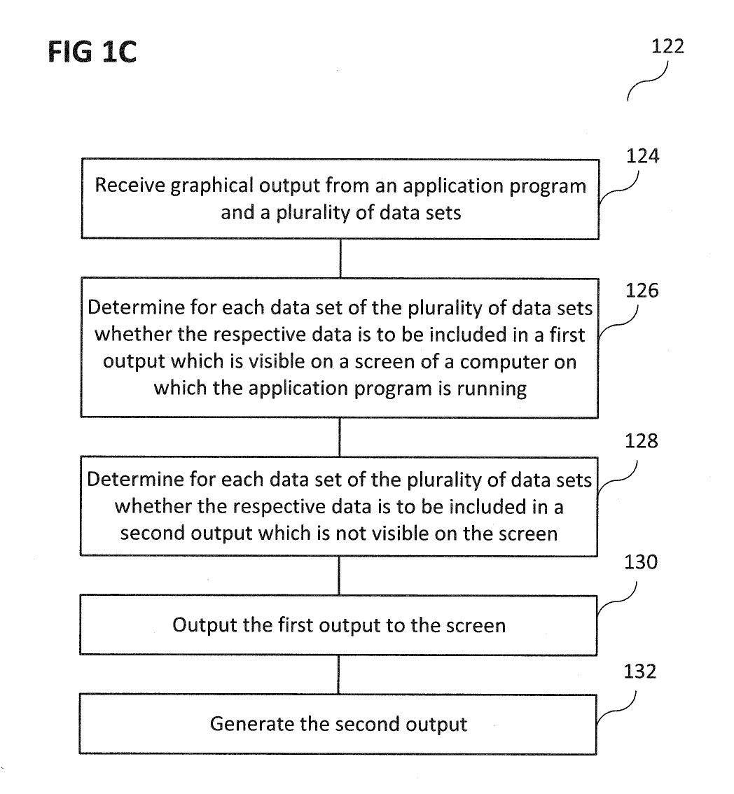

FIG. 1A shows a data processing device 100 according to various embodiments. The data processing device 100 may include an input circuit 102 configured to receive graphical output, wherein the graphical output may include any one or more of audio, video and text, (from an application program) and a plurality of data sets. The data processing device 100 may further include a determination circuit 104 configured to determine for each data set of the plurality of data sets whether the respective data is to be included in a first output which is visible on a screen of a computer on which the application program is running and to determine for each data set of the plurality of data sets whether the respective data is to be included in a second output which is not visible on the screen. The first output may include the respectively determined data sets and the graphical output from the application program. The second output may include the respectively determined data sets and the graphical output from the application program. The data processing device 100 tray further include a display interface 106 configured to output the first output to the screen. The computer may be the data processing device 100 or may be different from the data processing device 100. The data processing device 100 may further include an output generation circuit 108 configured to generate the second output. The input circuit 102, the determination circuit 104, the display interface 106, and the output generation circuit 108 may be coupled with each other, like indicated by lines 110, for example electrically coupled, for example using a line or a cable, and/or mechanically coupled. According to various embodiments, the second output may be hidden on the screen (in other words: may be invisible on the screen).

In other words, an output to a display may include gaming output and some data sets of a plurality of data sets, and another output to another device may include the gaming output, and some (other or identical) data sets of the plurality of data sets.

According to various embodiments, when generating the second output, it can be on the stored on the computer itself (as a data file format on the integrated/attached local storage (or media) such as computer internal memory, hard drive and etc.) or other computers through networks (wired or wireless), or other means of file transfer such as USB (universal serial bus) drive.

According to various embodiments, all data sets, sonic data sets, or none of data sets of the plurality of data sets may be included both in the first output and in the second output.

According to various embodiments, the plurality of data sets may include at least one data set related to a visible overlay which is to be included in the first output and in the second output.

According to various embodiments, the plurality of data sets may include at least one data set related to an invisible overlay which is to be included in the second output but not in the first output.

According to various embodiments, the plurality of data sets may include at least one data set related to a screen overlay which is to be included in the first output but not in the second output.

FIG. 1B shows a data processing device 112 according to various embodiments. The data processing device 112 may, similar to the data processing device 100 shown in FIG. 1A, include an input circuit 102 configured to receive graphical output (from an application program) and a plurality of data sets. The data processing device 112 may, similar to the data processing device 100 shown in FIG. 1A, further include a determination circuit 104 configured to determine for each data set of the plurality of data sets whether the respective data is to be included in a first output which is visible on a screen of a computer on which the application program is running and to determine for each data set of the plurality of data sets whether the respective data is to be included in a second output which is not visible on the screen. The first output may include the respectively determined data sets and the graphical output from the application program. The second output may include the respectively determined data sets and the graphical output from the application program. The data processing device 112 may, similar to the data processing device 100 shown in FIG. 1A, further include a display interface 106 configured to output the first output to a screen of the computer. The computer may be the data processing device 112 or may be different from the data processing device 112. The data processing device 112 may, similar to the data processing device 100 shown in FIG. 1A, further include an output generation circuit 108 configured to generate the second output. The data processing device 112 may further include a storage 114, like will be described in more detail below. The data processing device 112 may further include a network circuit 116, like will be described in more detail below. The data processing device 112 may further include a setting circuit 118, like will be described in more detail below. The input circuit 102, the determination circuit 104, the display interface 106, the output generation circuit 108, the storage 114, the network interface 116, and the, setting circuit 118 may be coupled with each other, like indicated by lines 120, for example electrically coupled, for example using a line or a cable, and/or mechanically coupled.

According to various embodiments, the storage 114 (which may be a storage internal or external to the data processing device 112 or internal to the computer, and which may include memory, such a volatile memory (like random access memory, RAM) or non-volatile memory (like a hard disk drive, HDD, or a solid state drive, or a USB (universal serial bus) stick) may be configured to store the second output.

According to various embodiments, the network interface 116 may be configured to output the second output to a device external to the computer on which the application program is running (for example for up-streaming).

According to various embodiments, the setting circuit 118 may be configured to receive user input to define for, a data set of the plurality of data sets whether the data set is to be included in the first output but not in the second output, whether the data set is to be included in the second output but not in the first output, or whether the data set is to be included both in the first output and in the second output.

According to various embodiments, the setting circuit 118 may be configured to receive user input to exclude a data set from the first output.

According to various embodiments, the setting circuit 118 may be configured to receive user input to exclude a data set from the second output.

According to various embodiments, the network interface 116 may be configured to output the second output to the device external to the data processing device 112 for storing on a storage device.

According to various embodiments, the network interface 1116 may be configured to output the second output to the device external to the data processing device 112 for-up-streaming.

According to various embodiments the application program may include or may be a computer game. According to various embodiments, the data sets to be included in the first output and in the second output may be provided by the computer game or by a computer program different from the computer game.

FIG. 1C shows a flow diagram 122 illustrating a data processing method according to various embodiments. In 124, graphical output from an application program and a plurality of data sets may be received. In 126, it may be determined for each data set of the plurality of data sets whether the respective data is to be included in a first output which is visible or a screen of a computer on which the application program is running. In 128, it may be determined for each data set of the plurality of data sets whether the respective data is to be included in a second output which is not visible on the screen. The first output may include the respectively determined data sets and the graphical output from the application program. The second output may include the respectively determined data sets and the graphical output from the application program. In 130, the first output may be output to the screen. In 132, the second output may be generated.

According to various embodiments, the data processing method may further include storing the second output.

According to various embodiments, the data processing method may further include outputting the second output to a device external to the computer on which the application program is running.

According to various embodiments, the plurality of data sets may include at least one data set related to a visible overlay which is to be included in the first output and in the second output.

According to various, embodiments, the plurality of data sets may include at least one data set related to an invisible overlay which is to be included in the second output but not in the first output.

According to various embodiments, the plurality of data sets may include at least one data scar related to a screen overlay which is to be included in the first output but not in the second output.

According to various embodiments, the data processing method may further include receiving user input to define for a data set of the plurality of data sets whether the data set is to be included in the first output but not in the second output, whether the data set is to be included in the second output but not in the first output, or whether the data set is to be included both in the first output and in the second output.

According to various embodiments, the data processing method may further include receiving user input to exclude a data set from the first output.

According to various embodiments, the data processing method may further include receiving user input to exclude a data set from the second output.

According to various embodiments, the data processing method may further include outputting the second output to the device external to the data processing device for storing on a storage device.

According to various embodiments, the data processing method may further include outputting the second output to the device external to the data processing device for up-streaming.

According to various embodiments, the application program may be a computer game.

According to various embodiments, computer-readable medium (for example a non-transitory computer-readable medium) may be provided. The computer-readable medium may include instructions which, when executed by a computer, make the computer perform a data processing method, the data processing method including: receiving graphical output from an application program and a plurality of data sets; determining for each data set of the plurality of data sets whether the respective data is to be included in a first output which is visible on a screen of a computer on which the application program is running; determining for each data set of the plurality of data sets whether the respective data is to be included in a second output which is not visible on the screen, wherein the first output includes the respectively determined data sets and the graphical output from the application program, wherein the second output includes the respectively determined data sets and the graphical output from the application program; outputting the first output to the screen; and generating the second output to a device external to the computer on which the application program is running.

According to various embodiments, the computer-readable medium may further include instructions which, when executed by a computer, make the computer perform storing the second output.

According to various embodiments, the computer-readable medium may further include instructions which, when executed by a computer, make the computer perform outputting the second output to a device external to the computer on which the application program is running.

According to various embodiments, the plurality of data sets may include at least one data set related to a visible overlay which is to be included in the first output and in the second output.

According to various embodiments, the plurality of data sets may include at least one data set related to an invisible overlay which is to be included in the second output but not in the first output.

According to various embodiments, the plurality of data sets may include at least one data set related to a screen overlay which is to be included in the first output but not in the second output.

According to various embodiments, the computer-readable medium may further include instructions which, when executed by a computer, make the computer perform receiving user input to define for a data set of the plurality of data sets whether the data set is to be included in the first output but not in the second output, whether the data set is to be included in the second output but not in the first output, or whether the data set is to be included both in the first output and in the second output.

According to various embodiments, the computer-readable medium may further include instructions which, when executed by a computer, make the computer perform receiving user input to exclude a data set from the first output.

According to various embodiments, the computer-readable medium may further include instructions which, when executed by a computer, make the computer perform receiving user input to exclude a data set from the second output.

According to various embodiments, the computer-readable medium may further include instructions which, when executed by a computer, make the computer perform outputting the second output to the device external to the data processing device for storing on a storage device.

According to various embodiments, the computer-readable medium may further include instructions which, when executed by a computer, make the computer perform outputting the second output to the device external to the data processing device for up-streaming.

According to various embodiments, the application program may be a computer game.

Various embodiments may be referred to as devices and methods with RIG Technology, for example Razer RIG Technology. RIG may stand for “Razer In-Game” Engine”.

Razer RIG may support DirectX and OpenGL games on Windows machines.

Razer RIG may injects into game sessions to host in-game overlay displays such that consumer of RIG service can build its in-game overlay apps and features.

RIG, for example Razer RIG, may use CEF (Chromium Embedded Framework) as its rendering mechanism or any other PC rendering mechanism to draw in-game and also web browser controls and API (application programming interface) for apps (applications) to build on.

FIG. 2 shows an illustration 200 of an architecture according to various embodiments (which may be referred to as RIG architecture). An operating system 202 (for example Windows 7, Windows 8, or Windows 10) may provide a basis for an operating system kernel and executives 204 (for example Windows kernel/executives). RIG 206, CEF 208, PC (personal computer) games 210, Direct X/OpenGL 212, or any other graphics engines, other PC applications 214, and PC inputs 216 may operate on top of the operating system kernel and executives 204.

According to various embodiments, three different in-game overlay categories may be provided such that both gamers and game viewers may take advantage of their interested in-game overlay composites for best gaming experience.

According to various embodiments, the following three types of in-game overlays may be provided: a visible overlay, an invisible overlay, and a screen overlay.

The visible overlay may be visible on a game and may be recorded along with the game. In other words: the visible overlay may be included in the first output and in the second output.

The invisible overlay may be invisible on a game. However, the invisible overlay may be recorded along with the game. In other words: the visible overlay may not be included in the first output, but may be included in the second output.

The screen overlay may be visible on a game, but cannot be recorded with the game. In other words: the visible overlay may be included in the first output, but may not be included in the second output.

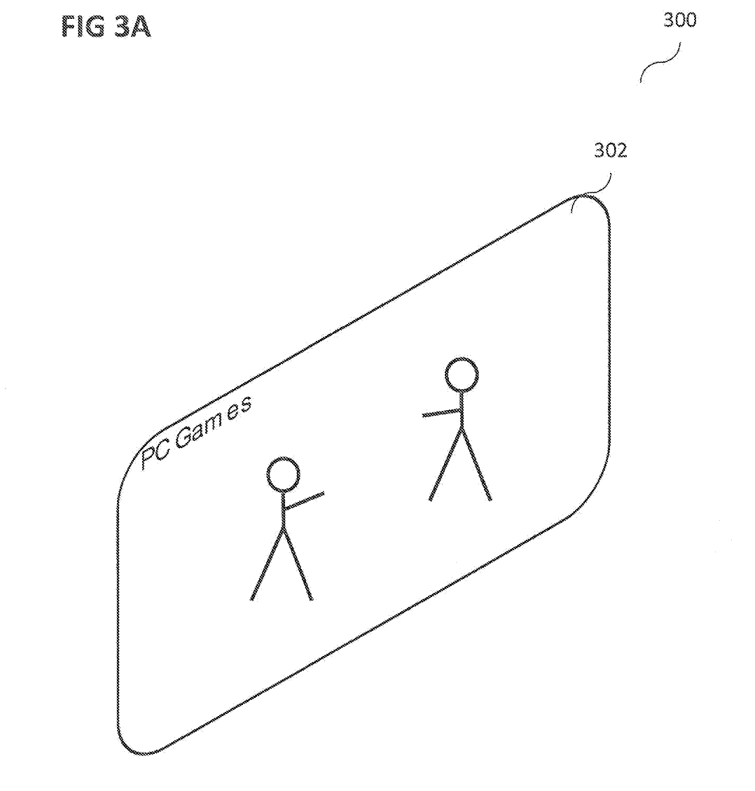

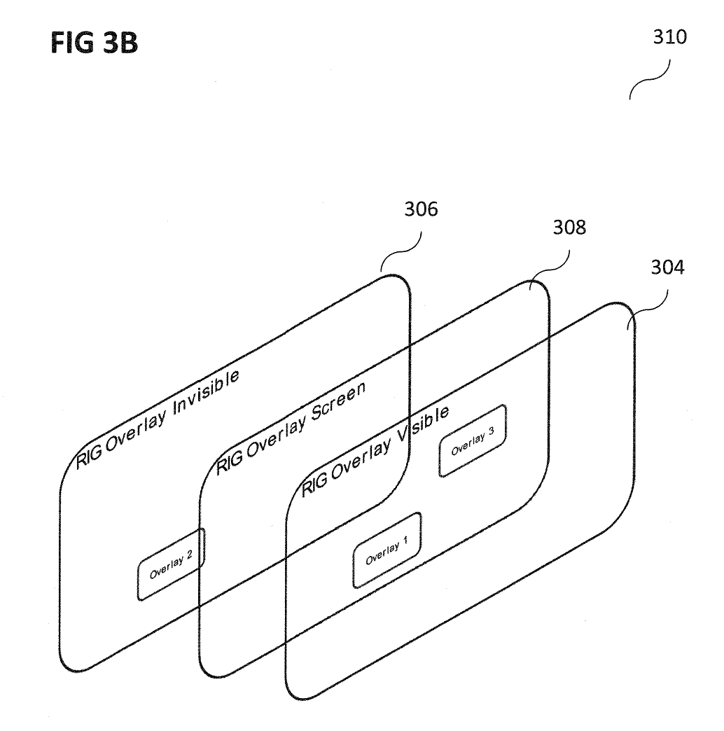

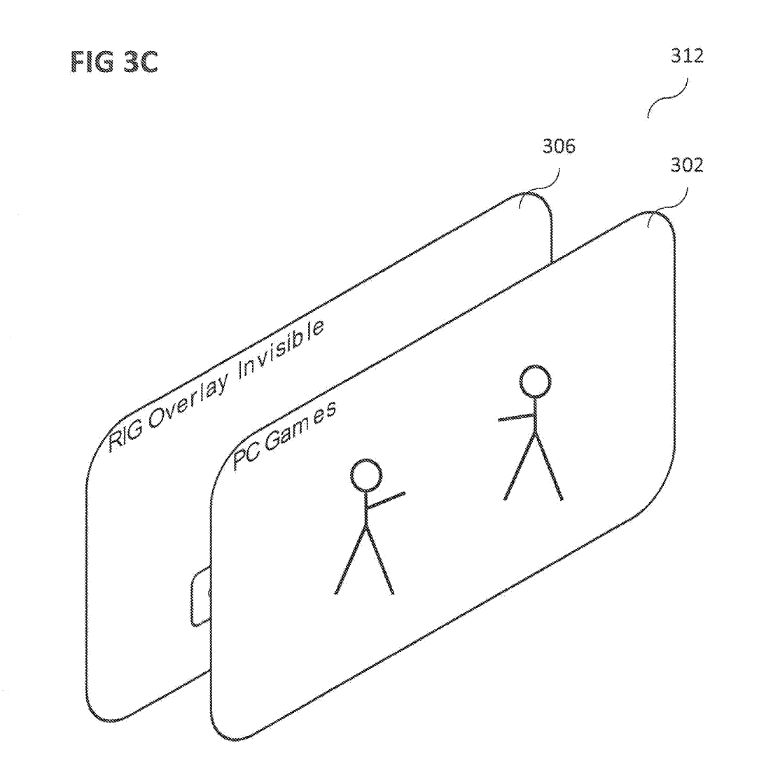

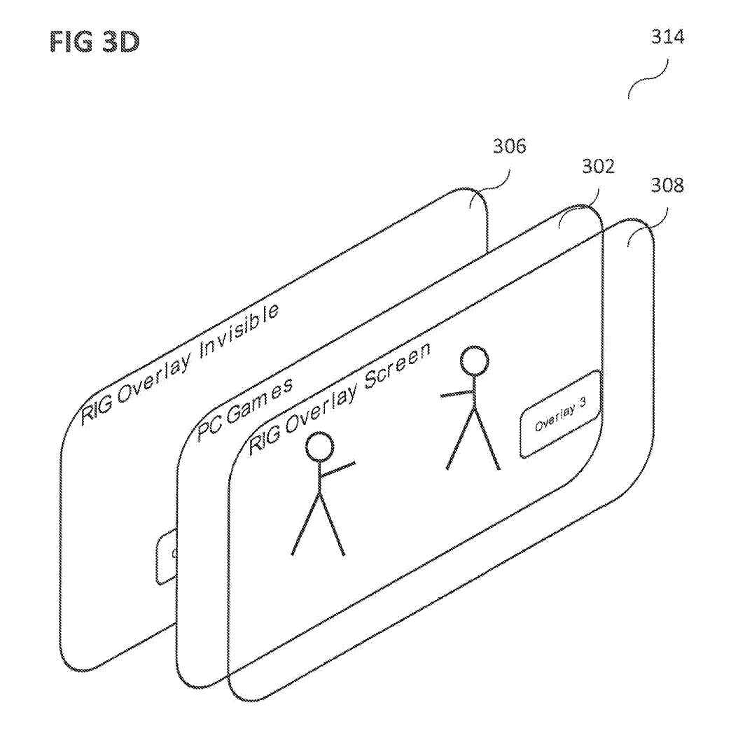

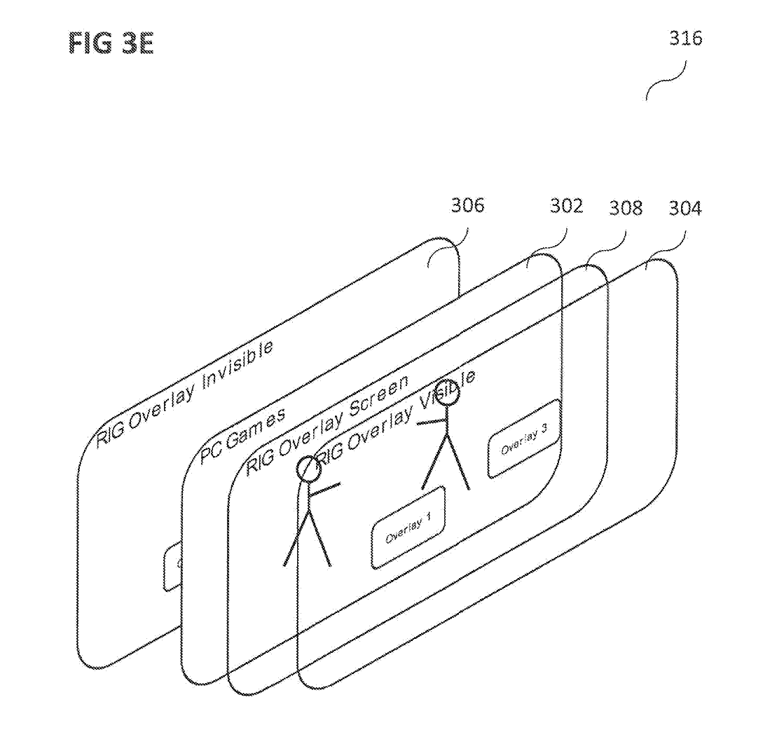

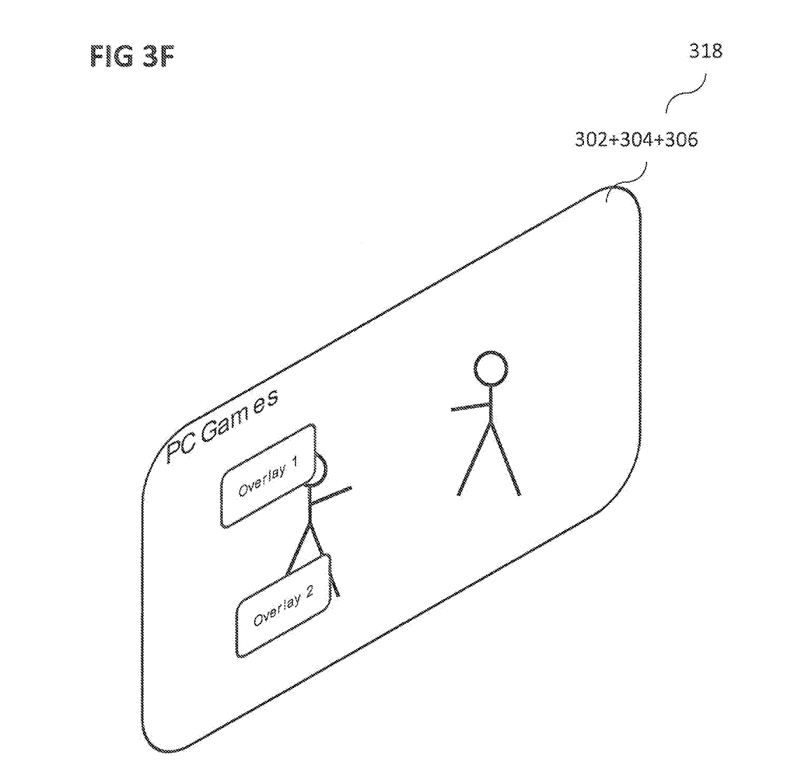

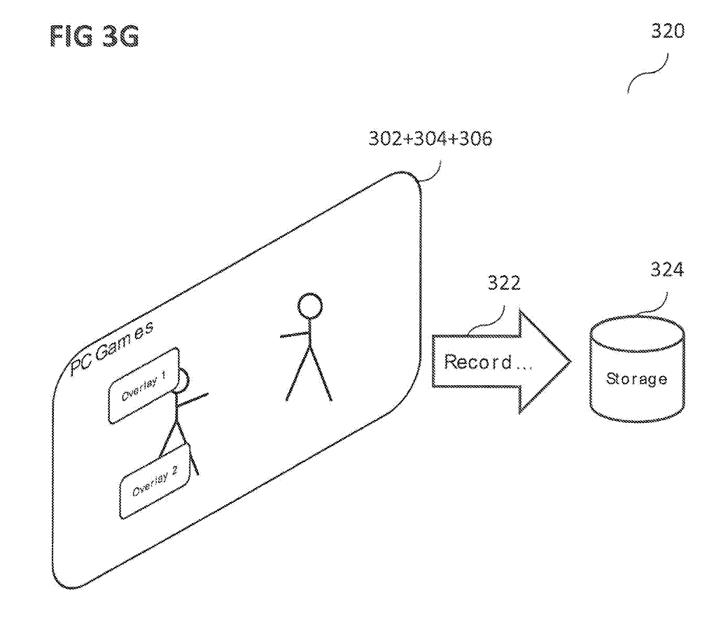

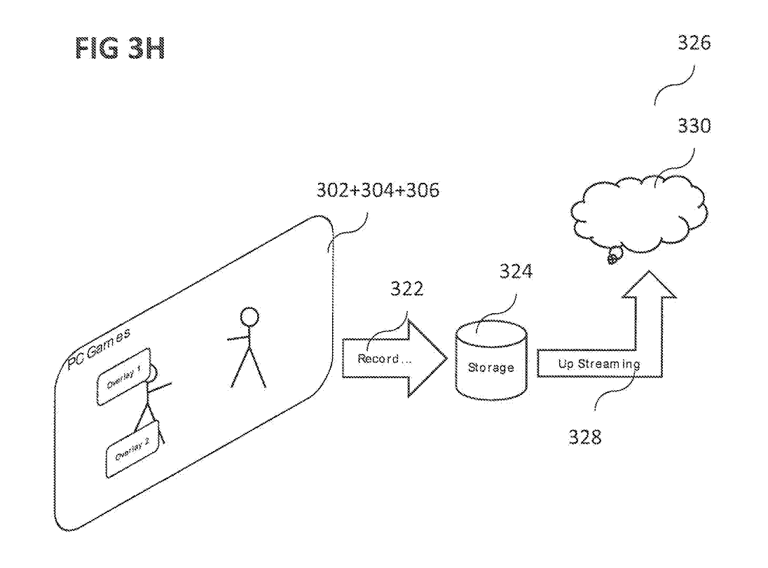

FIG. 3A to FIG. 3H show illustrations of an embodiment applied on a PC with a game playing. It will be understood that in FIG. 3A to FIG. 3H illustrations of contents of layers shown on a computer screen are shown, and that in order to illustrate the arrangement of the layers, a perspective view of the layers is shown, while actually, the layers may correspond to rectangular areas, for example display areas of a computer screen. The visual output 302 of the game may be shown on a screen (and may for sake of clarity include a graphical feature labelled “PC Games” and including illustrations of two characters in FIG. 3A to FIG. 3H), and may also be recorded (for example for storing and later playback, or it may be streamed to a plurality of viewers). Three kinds of overlays may be composed by using RIG: A first overlay 304, which may be a visible overlay, and which may for sake of clarity include a graphical feature labelled “overlay 1” in FIG. 3A to FIG. 31-1; a second overlay 306, which may be an invisible overlay (for instance, this may be a webcam feed), and which may for sake of clarity include a graphical feature labelled “overlay 2” in FIG. 3A to FIG. 3H; and a third overlay 308, which may be a screen overlay, and which may for sake of clarity include a graphical feature labelled “overlay 3” in FIG. 3A to FIG. 3H.

Using the “Inclusive and Exclusive technology” according to various embodiments, a game session recording source with the first overlay 304 and the second overlay 306 (and the output 302 of the game itself) may be created.

It will be understood that the gamer still cannot see the second overlay 306, which is only interested in by viewers. Furthermore, the third overlay 308 may not be recordable.

FIG. 3A shows an illustration 300 of the output 302 of the game (for example a PC game display on a PC computer).

FIG. 3B shows an illustration 310 of RIG in-game overlays, for example the visible overlay 304 the screen overlay 308, and the overlay 306

FIG. 3C shows an illustration 312 of RIG in-game overlays, for example illustrating adding the invisible overlay 306 to the output 302 of the game.

FIG. 3D shows an illustration 314 of RIG in-game overlays, for example illustrating adding a screen overlay 308 (in other words: and overlay Screen) to the overlays shown in FIG. 3C.

FIG. 3E shows an illustration 316 of RIG in-game overlays, for example illustrating adding the visible overlay 304 to the overlays shown in FIG. 3D.

FIG. 3F shows an illustration 318 of RIG in-game overlays for recording. The first overlay 304 and the second overlay 306 are selected and recorded, but the third overlay 308 may not be recorded.

FIG. 3G shows an illustration 320 of storing RIG in-game overlays. For example, what has been shown in FIG. 3F may be recorded, like illustrated by arrow 322, into a storage 324.

FIG. 3H shows an illustration 326 of up-streaming RIG in-game overlays. For example, what has been stored like illustrated in FIG. 3G may be up-streamed, like illustrated by arrow 328, into the cloud 330 (for example to a plurality of viewers).

Various embodiments may be useful and flexible for various in-game overlay scenarios, for example with in-game streaming eSport editing and etc.

The following examples pertain to further embodiments.

Example 1 is a data processing device comprising: an input circuit configured to receive graphical output from an application program and a plurality of data sets; a determination circuit configured to determine for each data set of the plurality of data sets whether the respective data is to be included in a first output which is visible on a screen of a computer on which the application program is running and to determine for each data set of the plurality of data sets whether the respective data is to be included in a second output which is not visible on the screen, wherein the first output comprises the respectively determined data sets and the graphical output from the application program, wherein the second output comprises the respectively determined data sets and the graphical output from the application program; a display interface configured to output the first output to the screen; and an output generation circuit configured to generate the second output.

In example 2, the subject-matter of example 1 can optionally include a storage configured to store the second output.

In example 3, the subject-matter of any one of examples 1 to 2 can optionally include a network interface configured to output the second output to a device external to the computer on which the application program is running.

In example 4, the subject-matter of any one of examples 1 to 3 can optionally include that the plurality of data sets comprises at least one data set related to a visible overlay which is to be included in the first output and in the second output.

In example 5, the subject-matter of any one of examples 1 to 4 can optionally include that the plurality of data sets comprises at least one data set related to an invisible overlay which is to be included in the second output but not in the first output.

In example 6, the subject-matter of any one of examples 1 to 5 can optionally include that the plurality of data sets comprises at least one data set related to a screen overlay which is to be included in the first output but not in the second output.

In example 7, the subject-matter of any one of examples 1 to 6 can optionally include a setting circuit configured to receive user input to define for a data set of the plurality of data sets whether the data set is to be included in the first output but not in the second output, whether the data set is to be included in the second output but not in the first output, or whether the data set is to be included both in the first output and in the second output.

In example 8, the subject-matter of any one of examples 1 to 7 can optionally include a setting circuit configured to receive user input to exclude a data set from the first output.

In example 9, the subject-matter of any one of examples 1 to 8 can optionally include a setting circuit configured to receive user input to exclude a data set from the second output.

In example 10, the subject-matter of example 3 can optionally include that the network interface is configured to output the second output to the device external to the data processing device for storing on a storage device.

In example 11 the subject-matter of any one of examples 3 or 10 can optionally include that the network interface is configured to output the second output to the device external to the data processing device for up-streaming.

In example 12, the subject-matter of any one of examples 1 to 11 can optionally include that the application program is a computer game.

In example 13 the subject-matter of any one of examples 1 to 12 can optionally include that at least one of the first output or the second output is used in at least one of a single frame or a multi-frame usage.

Example 14 is a data processing method comprising: receiving graphical output from an application program and a plurality of data sets; determining for each data set of the plurality of data sets whether the respective data is to be included in a first output which is visible on a screen of a computer on which the application program is running; determining for each data set of the plurality of data sets whether the respective data is to he included in a second output which is not visible on the screen, wherein the first output comprises the respectively determined data sets and the graphical output from the application program, wherein the second output comprises the respectively determined data sets and the graphical output from the application program; outputting the first output to the screen; and generating the second output.

In example 15, the subject-matter of example 14 can optionally include storing the second output.

In example 16, the subject-matter of any one of examples 14 to 15 can optionally include outputting the second output to a device external to the computer on which the application program is running.

In example 17, the subject-matter of any one of examples 14 to 16 can optionally include that the plurality of data sets comprises at least one data set related to a visible overlay which is to be included in the first output and in the second output.

In example 18, the subject-matter of any one of examples 14 to 17 can optionally include that the plurality of data sets comprises at least one data set related to an invisible overlay which is to be included in the second output but not in the first output.

In example 19, the subject-matter of any one of examples 14 to 18 can optionally include that the plurality of data sets comprises at least one data set related to a screen overlay which is to be included in the first output but not in the second output.

In Example 20, the subject-matter of any one of examples 14 to 19 can optionally include receiving user input to define for a data set of the plurality of data sets whether the data set is to be included in the first output but not in the second output, whether the data set is to be included in the second output but not in the first output, or whether the data set is to be included both in the first output and in the second output.

In example 21, the subject-matter of any one of examples 14 to 20 can optionally include receiving user input to exclude a data set from the first output.

In example 22, the subject-matter of any one of examples 14 to 21 can optionally include receiving user input to exclude a data set from the second output.

In example 23, the subject-matter of any one of examples 14 to 22 can optionally include outputting the second output to the device external to the data processing device tor storing on a storage device.

In example 24, the subject-matter of any one of examples 14 to 23 can optionally include outputting the second output to the device external to the data processing device for up-streaming.

In example 25, the subject-matter of any one of examples 14 to 24 can optionally include that the application program is a computer game.

In example 26, the subject-matter of any one of examples 14 to 25 can optionally include that at least one of the first output or the second output is used in at least one of a single frame or a multi-frame usage.

Example 27 is a computer-readable medium comprising instructions which, when executed by a computer, make the computer perform a data processing method, the data processing, method comprising: receiving graphical output from an application program and a plurality of data sets; determining for each data set of the plurality of data sets whether the respective data is to be included in a first output which is visible on a screen of a computer on which the application program is running; determining for each data set of the plurality of data sets whether the respective data is to be included in a second output which is not visible on the screen, wherein the first output comprises the respectively determined data sets and the graphical output from the application program, wherein the second output comprises the respectively determined data sets and the graphical output from the application program; outputting the first output to the screen; and generating the second output.

In example 28, the subject-matter of example 27 can optionally include that instructions which, when executed by a computer, make the computer perform storing the second output.

In example 29, the subject-matter of any one of examples 27 to 28 can optionally include instructions which, when executed by a computer, make the computer perform outputting the second output to a device external to the computer on which the application program is running.

In example 30, the subject-matter of any one of examples 27 to 29 can optionally include that the plurality of data sets comprises at least one data set related to a visible overlay which is to be included in the first output and in the second output.

In example 31, the subject-matter of any one of examples 27 to 30 can optionally include that the plurality of data sets comprises at least one data set related to an invisible overlay which is to be included in the second output but not in the first output.

In example 32, the subject-matter of any one of examples 27 to 31 can optionally include that the plurality of data sets comprises at least one data set related to a screen overlay which is to be included in the first output but not in the second output,

In example 33, the subject-matter of any one of examples 27 to 32 can optionally include instructions which, when executed by a computer, make the computer perform receiving user input to define for a data set of the plurality of data sets whether the data set is to be included in the first output but not in the second output, whether the data set is to be included in the second output but not in the first output, or whether the data set is to be included both in the first output and in the second output.

In example 34, the subject-matter of any one of examples 27 to 33 can optionally include instructions which, when executed by a computer, make the computer perform receiving user input to exclude a data set from the first output.

In example 35, the subject-matter of any one of examples 27 to 34 can optionally include instructions which, when executed by a computer, make the computer perform receiving user input to exclude a data set from the second output.

In example 36, the subject-matter of any one of examples 27 to 35 can optionally include instructions which, when executed, by a computer, make the computer perform outputting the second output to the device external to the data processing device for storing on a storage device.

In example 37, the subject-matter of any one of examples 27 to 36 can optionally include instructions which, when executed by a computer, make the computer perform outputting the second output to the device external to the data processing device for up-streaming.

In example 38 the subject-matter of any one of examples 27 to 37 can optionally include that the application program is a computer game.

In example 39 the subject-matter of any one of examples 27 to 38 can optionally include that at least one of the first output or the second output is used in at least one of a single frame or a multi-frame usage.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A data processing device comprising:
an input circuit configured to receive graphical output from an application program and a plurality of data sets;
a determination circuit configured to determine for each data set of the plurality of data sets whether the respective data is to be included in a first output which is visible on a screen of a computer on which the application program is running and to determine for each data set of the plurality of data sets whether the respective data is to be included in a second output which is not visible on the screen,
wherein the first output comprises the respectively determined data sets and the graphical output from the application program,
wherein the second output comprises the respectively determined data sets and the graphical output from the application program;
a display interface configured to output the first output to the screen; and
an output generation circuit configured to generate the second output.

2. The data processing device of claim 1, further comprising:
a storage configured to store the second output.

3. The data processing device of claim 1, further comprising:
a network interface configured to output the second output to a device external to the computer on which the application program is running.

4. The data processing device of claim 1,
wherein the plurality of data sets comprises at least one data set related to a visible overlay which is to be included in the first output and in the second output.

5. The data processing device of claim 1,
wherein the plurality of data sets comprises at least one data set related to an invisible overlay which is to be included in the second output but not in the first output.

6. The data processing device of claim 1,
wherein the plurality of data sets comprises at least one data set related to a screen overlay which is to be included in the first output but not in the second output.

7. The data processing device of claim 1, further comprising:
a setting circuit configured to receive user input to define for a data set of the plurality of data sets whether the data set is to be included in the first output but not in the second output, whether the data set is to be included in the second output but not in the first output, or whether the data set is to be included both in the first output and in the second output.

8. The data processing device of claim 1, further comprising:
a setting circuit configured to receive user input to exclude a data set from the first output.

9. The data processing device of claim 1,
wherein the network interface is configured to output the second output to a device external to the data processing device for storing on a storage device.

10. The data processing device of claim 1,
wherein the network interface is configured to output the second output to a device external to the data processing device for up-streaming.

11. A data processing method comprising:
receiving graphical output from an application program and a plurality of data sets;
determining for each data set of the plurality of data sets whether the respective data is to be included in a first output which is visible on a screen of a computer on which the application program is running;
determining for each data set of the plurality of data sets whether the respective data is to be included in a second output which is not visible on the screen,
wherein the first output comprises the respectively determined data sets and the graphical output from the application program,
wherein the second output comprises the respectively determined data sets and the graphical output from the application program;
outputting the first output to the screen; and
generating the second output.

12. The data processing method of claim 11, further comprising:
storing the second output.

13. The data processing method of claim 11, further comprising:
outputting the second output to a device external to the computer on which the application program is running.

14. The data processing method of claim 11,
wherein the plurality of data sets comprises at least one data set related to a visible overlay which is to be included in the first output and in the second output.

15. The data processing method of claim 11,
wherein the plurality of data sets comprises at least one data set related to an invisible overlay which is to be included in the second output but not in the first output.

16. The data processing method of claim 11,
wherein the plurality of data sets comprises at least one data set related to a screen overlay which is to be included in the first output but not in the second output.

17. The data processing method of claim 11, further comprising:
receiving user input to define for a data set of the plurality of data sets whether the data set is to be included in the first output but not in the second output, whether the data set is to be included in the second output but not in the first output, or whether the data set is to be included both in the first output and in the second output.

18. The data processing method of claim 11, further comprising:
receiving user input to exclude a data set from the first output.

19. The data processing method of claim 11, further comprising:
outputting the second output to the device external to a data processing device for storing on a storage device or for up-streaming.

20. (canceled)

21. A non-transitory computer-readable medium comprising instructions which, when executed by a computer, make the computer perform a data processing method, the data processing method comprising:
receiving graphical output from an application program and a plurality of data sets;
determining for each data set of the plurality of data sets whether the respective data is to be included in a first output which is visible on a screen of a computer on which the application program is running;
determining for each data set of the plurality of data sets whether the respective data is to be included in a second output which is not visible on the screen,
wherein the first output comprises the respectively determined data sets and the graphical output from the application program,
wherein the second output comprises the respectively determined data sets and the graphical output from the application program;
outputting the first output to the screen; and
generating the second output.

22-30. (canceled)
